(19) United States
(12) Patent Application Publication
(10) Pub. No.: US 2004/0225997 A1
(43) Pub. Date: Nov. 11, 2004

(54) Efficient computation of line information in a token-oriented representation of program code

(75) Inventors: Michael L. Van De Vanter, Mountain View, CA (US); Kenneth B. Urquhart, Bellevue, WA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/430,538

(22) Filed: May 6, 2003

(51) Int. Cl. G06F 9/44

(52) U.S. Cl. 717/109; 717/113

(57) ABSTRACT

An editor, software engineering tool or collection of such tools may be configured to encode (or employ an encoding of) an insertion point representation that identifies a particular token of a token-oriented representation and offset thereinto, together with at least some line-oriented coordinates. Efficient implementations of insert and remove operations that employ such a representation are described herein. Computational costs of such operations typically scale at worst with the size of fragments inserted into and/or removed from such a token-oriented representation, rather than with buffer size. Accordingly, such implementations are particularly well-suited to providing efficient support for programming tool environments in which a token stream is updated incrementally in correspondence with user edits.

### CROSS-REFERENCE TO RELATED APPLICATION(S)

This application is related to commonly-owned U.S. patent application Ser. Nos. 10/185,752, 10/185,753, 10/185,754 and 10/185,761, each naming Van De Vanter and Urquhart as inventors and each filed on Jun. 28, 2002.

### BACKGROUND

1. Field of the Invention

The present invention relates generally to interactive software engineering tools including editors for source code such as a programming code or mark-up language, and more particularly to facilities for supporting edit or other operations on a token-oriented representation of code or content.

2. Description of the Related Art

In an editor for computer programs, it can be desirable to represent program code using a token-oriented representation, rather than simply as a linear sequence of characters. In such a representation, the linear sequence of characters that corresponds to program code may be divided into substrings corresponding to the lexical tokens of the particular language. In some implementations, this representation of a stream of tokens can updated incrementally after each user action (for example, after each keystroke) using techniques such as those described in U.S. Pat. No. 5,737,608 to Van De Vanter, entitled “PER KEYSTROKE INCREMENTAL LEXING USING A CONVENTIONAL BATCH LEXER.” In general, such updates may employ a facility that allows insertion and/or deletion of tokens in or from the token stream.

Such updates may be expressed in terms of particular token-coordinates positions in a token stream, referring to a particular token and location of a particular character in the token. Although some operations of an editor may be expressed in this way, other operations, particularly text-oriented operations or program state accesses employed by some programming tools such as compilers, source-level debuggers etc., may benefit from traversal of a program representation as if it were organized as lines of code or other content. What is needed is a representation that satisfies both requirements and can efficiently support frequently performed operations, such as insertion of tokens in and/or deletion of tokens from the representation.

### SUMMARY

It has been discovered that an editor, software engineering tool or collection of such tools may be configured to encode (or employ an encoding of) an insertion point representation that identifies a particular token of a token-oriented representation and offset thereinto, together with at least some line-oriented coordinates. Efficient implementations of insert and remove operations that employ such a representation are described herein. Computational costs of such operations typically scale at worst with the size of fragments inserted into and/or removed from such a token-oriented representation, rather than with buffer size. Accordingly, such implementations are particularly well-suited to providing efficient support for programming tool environments in which a token stream is updated incrementally in correspondence with user edits. These and other implementations will be understood with reference to the specification and claims that follow.

### BRIEF DESCRIPTION OF THE DRAWINGS

The present invention may be better understood, and its numerous objects, features, and advantages made apparent to those skilled in the art by referencing the accompanying drawings.

FIG. 1 depicts operation of one or more software engineering tools that operate on and/or maintain a tokenized program representation in accordance with some embodiments of the present invention.

FIG. 2 depicts in greater detail a tokenized program representation with an insertion point encoding in accordance with some embodiments of the present invention.

FIGS. 3A and 3B illustrate, in accordance with some embodiments of the present invention, states of a tokenized program representation in relation to operations that insert tokens into the program representation, typically in response to user edits. In particular, FIGS. 3A and 3B illustrate states before and after an edit operation that inserts tokens into the representation.

FIGS. 4A and 4B illustrate, in accordance with some embodiments of the present invention, states of a tokenized program representation in relation to operations that remove tokens from the program representation, typically in response to user edits. In particular, FIGS. 4A and 4B illustrate states before and after an edit operation that removes tokens from the representation.

FIGS. 5A and 5B illustrate, in accordance with some embodiments of the present invention, states of a tokenized program representation in relation to operations that insert an additional line boundary, typically in response to user edits. In particular, FIGS. 5A and 5B illustrate states before and after an edit operation that insert an EOL token in the representation.

FIGS. 6A and 6B illustrate, in accordance with some embodiments of the present invention, states of a tokenized program representation in relation to operations that delete a line boundary, typically in response to user edits. In particular, FIGS. 6A and 6B illustrate states before and after an edit operation that remove an EOL token from the representation.

FIG. 7 depicts interactions between various functional components of an exemplary editor implementation that employs a token-oriented representation and for which insertion point support may be provided in accordance with techniques of the present invention.

The use of the same reference symbols in different drawings indicates similar or identical items.

### DESCRIPTION OF THE PREFERRED EMBODIMENT(S)

Exploitations of the techniques of the present invention are many. In particular, a variety of software engineering tools are envisioned, which employ aspects of the present invention to facilitate edit and/or navigation operations on a token-oriented representation of program code. One exemplary software engineering tool is a source code editor that provides specialized behavior or typography based on lexical context using a tokenized program representation. Such a source code editor provides a useful descriptive context in which to present various aspects of the present invention. Nonetheless, the invention is not limited thereto. Indeed, applications to editors, analyzers, builders, compilers, debuggers and other such software engineering tools are envisioned. In this regard, some exploitations of the present invention may provide language-oriented behaviors within suites of tools or within tools that provide functions in addition to manipulation of program code.

In addition, while traditional procedural or object-oriented programming languages provide a useful descriptive context, exploitations of the present invention are not limited thereto. Indeed, other software engineering tool environments such as those adapted for editing, analysis, manipulation, transformation, compilation, debugging or other operations on functionally descriptive information or code, such as other forms of source code, machine code, bytecode sequences, scripts, macro language directives or information encoded using markup languages such as HTML or XML, may also employ structures, methods and techniques in accordance with the present invention. Furthermore, the structures, methods and techniques of the present invention may be exploited in the manipulation or editing of non-functional, descriptive information, such as software documentation or even prose. Based on the description herein, persons of ordinary skill in the art will appreciate applications to a wide variety of tools and language contexts.

Accordingly, in view of the above and without limitation, an exemplary exploitation of the present invention is now described.

Tokenized Program Representation

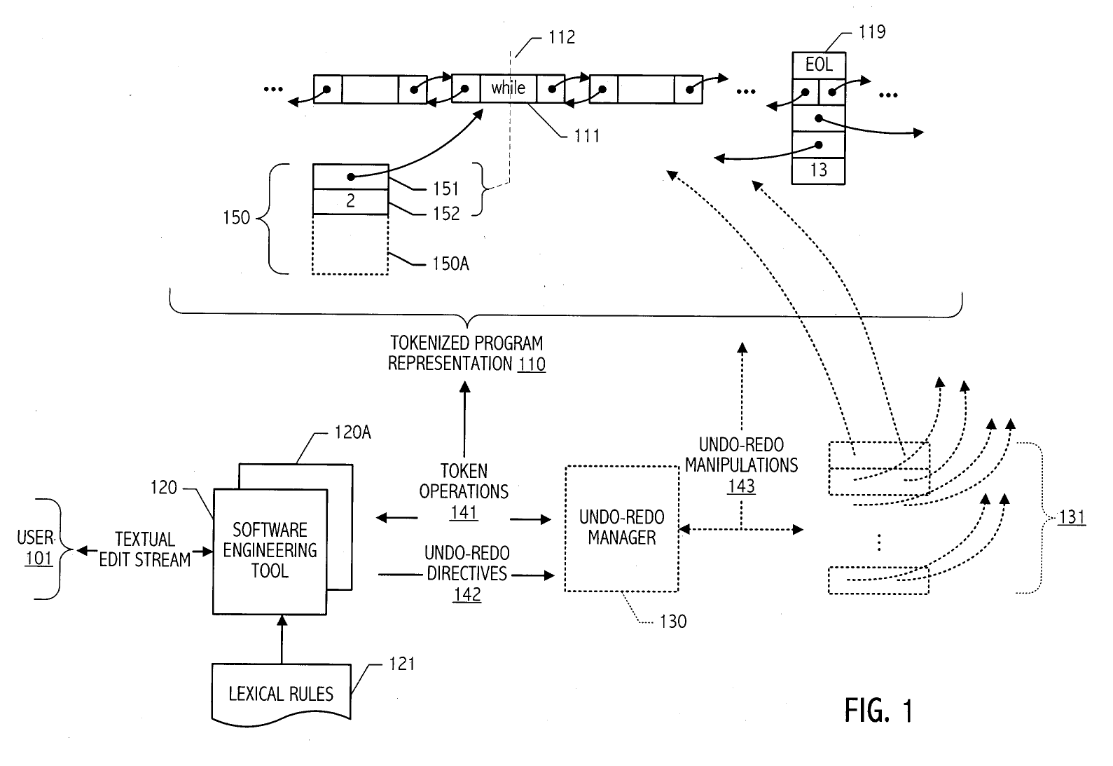

FIG. 1 depicts operation of one or more software engineering tools (e.g., software engineering tools 120 and 120A) that operate on, maintain and/or traverse a tokenized representation of information, such as tokenized program representation 110. In FIG. 1, a doubly-linked list representation of tokenized program code is illustrated with line boundary demarcations. Of course, any of a variety of variable-size structures that support efficient insertion and removal may be employed. For example, although the illustration of FIG. 1 suggests plural nodes configured in a doubly-linked list arrangement with textual information associated with each such node, other information and coding arrangements are possible. In some realizations, node-associated information may be encoded by reference, i.e., by a pointer identifying the associated information, or using a token code or label. In some variations, identical textual or other information content associated with different nodes may be encoded as multiple pointers to a same representation of such information. In some realizations, information may even be encoded in the body of a node's structure itself. Whatever the particular design choice, the illustrated doubly-linked list encoding provides a flexible way of representing the tokenized program content and provides a useful illustrative context.

In general, language-oriented properties can be separated from the list structure. For example, in the illustrated tokenized program representation 110, a character sequence (e.g., that corresponding to a computer program or portion thereof) is represented as a doubly-linked list of text strings, while the language (lexical) properties of the strings can be isolated from the list structure by storing references to associated strings in each node. In this way, structures and methods of manipulation can be implemented without bias to a particular language, and language-oriented behaviors can be implemented or supported in a modular fashion. In addition, multiple lexical contexts and/or embedded lexical contexts may be efficiently supported. In general, when a character sequence is stored or represented, the total amount of storage or memory employed can be substantially reduced by storing a pointers to an associated text string encoding and such encodings may be referenced by the various nodes that correspond to uses of a particular string (or token) in a given program representation. Storage for the text strings can be managed separately from the storage for the nodes. For example, when allocating a string for a new node (or token), existing strings may be checked to see if a corresponding string already exists. Strings corresponding to valid language tokens may be pre-allocated and indexed using a token identifier, hash or any other suitable technique.

In the illustration of FIG. 1, an insertion point representation (e.g., insertion point 150) is used to identify a particular point in the tokenized list structure at which edit operations operate. The insertion point may be manipulated by navigation operations, as a result of at least some edit operations, or (in some configurations) based on operations of a programming tool such as a source level debugger. A variety of insertion point representations are suitable, including insertion point representations that encode line identifiers, line offsets, text offsets and/or total buffer size. The illustrated insertion point representation includes an encoding of token coordinates using token pointer 151 and offset 152 thereinto, together with a line coordinates encoding 150A. Typically, line coordinates encoding 150A identifies a relevant line boundary demarcation, e.g., end-of-line (EOL) token 119, together with additional information such as a line number and/or an offset into the line. Using such an insertion point representation, a particular position in tokenized program representation 110, e.g., position 112 immediately before the character “i” in the text string representation corresponding to language token 111, is identified. In addition, line-coordinates information is also encoded. The insertion point representation is maintained consistent with edit operations and navigation operations. In a given insertion point representation, additional information may also be encoded (and maintained) to facilitate operations of various software engineering tools. In particular, some representations include a further character-coordinates representation, e.g., total text offset into tokenized program representation 110, and a total buffer length encoding.

Many variations on the illustrated insertion point representation are envisioned. For example, in some exploitations, additional character-coordinates representations may be may be included while in others such features may be omitted, disabled or unused. Similarly, total buffer length and/or line length encodings are optional for some exploitations. In addition, while straightforward implementations tend to represent offsets as positive offsets from a lowest order base position (e.g., a positive text offset from a beginning of string or beginning of token position), other variations are possible. For example, offsets (including negative offsets) from other positions such as an end of string or token position (or line or buffer boundary) may be employed. More generally, any arbitrary base/offset convention may be employed, including from arbitrary or predetermined way points in a program representation. These and other variations may fall within the scope of certain claims that follow. Nonetheless, for clarity of illustration, the description that follows focuses on a straightforward zero-base and positive offset convention.

Furthermore, insertion point representations are susceptible to a variety of suitable encodings including as data structures that identically or non-identically represent some or all of the data of the illustrated insertion point representation 150. For example, data may be encoded in, or in association with, an insertion point representation to improve the efficiency of manipulations of the tokenized program representation. Similarly, certain aspects of the represented data may be hierarchically organized and/or referenced by value to facilitate transformations and/or undo-redo caching that may be employed in some realizations. For purposes of this description, any of a variety of insertion point encodings are suitable.

As illustrated in FIG. 1, one or more software engineering tools may operate on the contents of tokenized program representation 110 using token operations 141. Illustrative token operations include insertion and removal of tokens in or from tokenized program representation 110. Lexical rules 121 facilitate decomposition, analysis and/or parsing of a textual edit stream, e.g., that supplied through interactions with user 101, to transform textual operations into token oriented operations. In general, any of a variety of lexical analysis techniques may be employed. However, in some implementations, tokens are updated incrementally after each user action (for example, after each keystroke) using incremental techniques such as those described in U.S. Pat. No. 5,737,608 to Van De Vanter, entitled “PER KEYSTROKE INCREMENTAL LEXING USING A CONVENTIONAL BATCH LEXER,” the entirety of which in incorporated herein by reference. Other lexical analysis techniques may be employed in a given implementation. Whatever the techniques employed, a textual edit stream will, in general, result in updates to tokenized program representation 110 that can be defined in terms of insertions and deletions of one or more tokens thereof. The description that follows describes insertion and deletion operations and associated representations that facilitate efficient handling of such operations.

In some realizations, an optional undo-redo manager 130 maintains a collection 131 of undo-redo objects or structures that facilitate manipulations of tokenized program representation 110 to achieve the semantics of undo and redo operations. In general, such an undo-redo manager is responsive to undo-redo directives 142 supplied by software engineering tool 120 and interacts with tokenized program representation 110 and the undo-redo objects in accordance therewith. Typically, undo-redo directives are themselves responsive to user manipulations, although other sources (such as from automated tools) are also possible. In the illustration of FIG. 1, individual undo-redo structures identify respective nodes of the tokenized program representation (including those corresponding to inserted or removed tokens) to facilitate undo and redo operations. Suitable undo-redo implementations and support are described in greater detail in co-pending U.S. patent application Ser. No. ______ {Atty. Docket No. 004-6210, entitled “UNDO/REDO WITH COMPUTED LINE INFORMATION IN A TOKEN-ORIENTED REPRESENTATION OF PROGRAM CODE,” naming Van De Vanter and Urquhart as inventors and filed on even date herewith}, which is incorporated herein by reference.

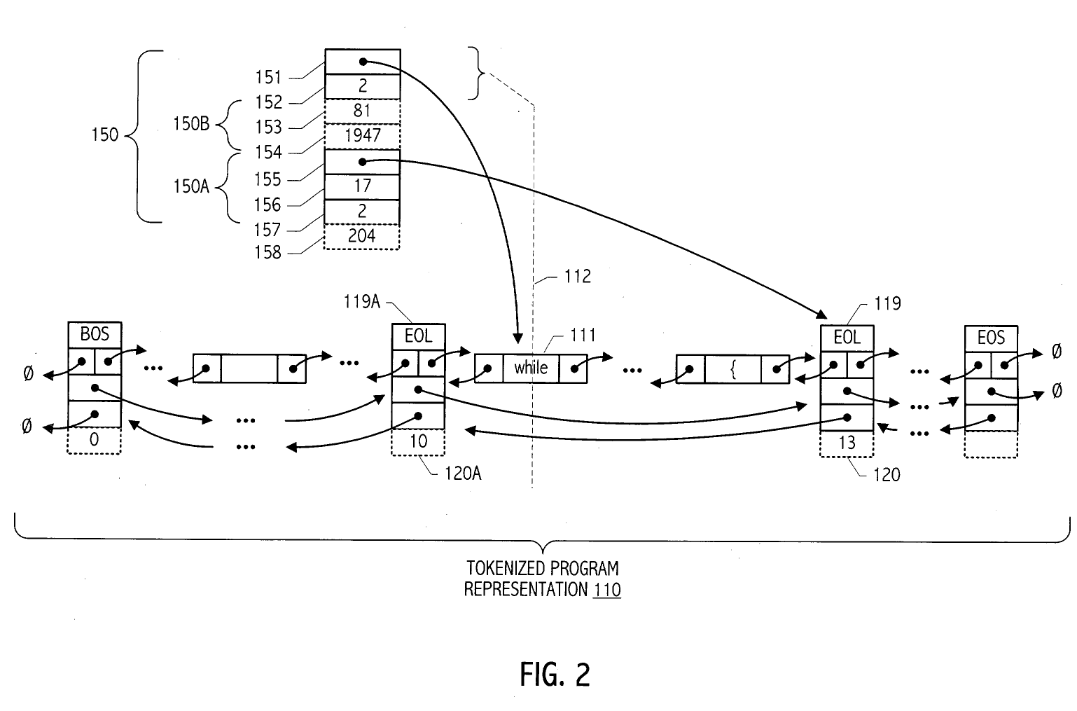

FIG. 2 depicts an illustrative state for a tokenized program representation including EOL tokens and an insertion point encoding in accordance with some embodiments of the present invention. As before, tokenized program representation 110 includes a doubly-linked list of lexical tokens and an insertion point representation 150 that identifies a particular position 112 therein. End-of-line EOL tokens (e.g., 119, 119A) mark line boundaries in the illustrated representation. Beginning-of-stream (BOS) and end-of-stream (EOS) are encoded as null terminated EOL tokens, although other realizations may employ other encodings. While appropriate line termination conventions may vary from system-to-system or implementation-to-implementation, in many systems and implementations, EOL tokens correspond to newline characters and, for the sake of illustration (though without limitation), the description that follows so-presumes.

In addition to the bi-directional intertoken pointers illustrated, tokenized program representation 110 provides an additional line-to-line traversal facility using an overlaid doubly-linked chain of pointers from EOL token to EOL token. An appropriate one of these EOL tokens (e.g., EOL token 119 which terminates the line in which position 112 resides) is identified by pointer 155 of line coordinates encoding 150A. Of course, use of a terminating EOL token (rather than, for example, a preceding token or other demarcation), is by convention only and other realizations may employ other conventions. In the illustrated configuration, line coordinates encoding 150A caches a line number (156) for the line which includes position 112 and a line offset (157) into the line in which position 112 appears.

The illustrated state of tokenized program representation 110 is state consistent with program code in which the textual content:

while (!done) {

appears at line 17 of a stream of edit buffer. Insertion point representation 150 includes both a token coordinates representation of the insertion point (e.g., where position 112 is identified as offset of 2 [see field 152] into token 111 identified by pointer 151) and a line-coordinates representation of the insertion point (e.g., position 112 is identified as using a line offset of 2 [see field 157] into the particular line 17 [see field 156] terminated by EOL token 119 identified by pointer 155). Not all fields need be provided in a given realization. Several additional optional features are also illustrated. For example, insertion point representation 150 caches (at field 158) a total line count (e.g., 204 lines). In addition, insertion point representation 150 also caches a text-coordinates representation of the insertion point (e.g., position 112 is further identified as character position 81 [see field 153]) in a buffer of 1947 [see field 154] characters. Character-coordinates features 150B are optional, though, if provided, caching of line sizes (e.g., in or associated with respective EOL tokens, as shown in fields 120, 120A) is desirable.

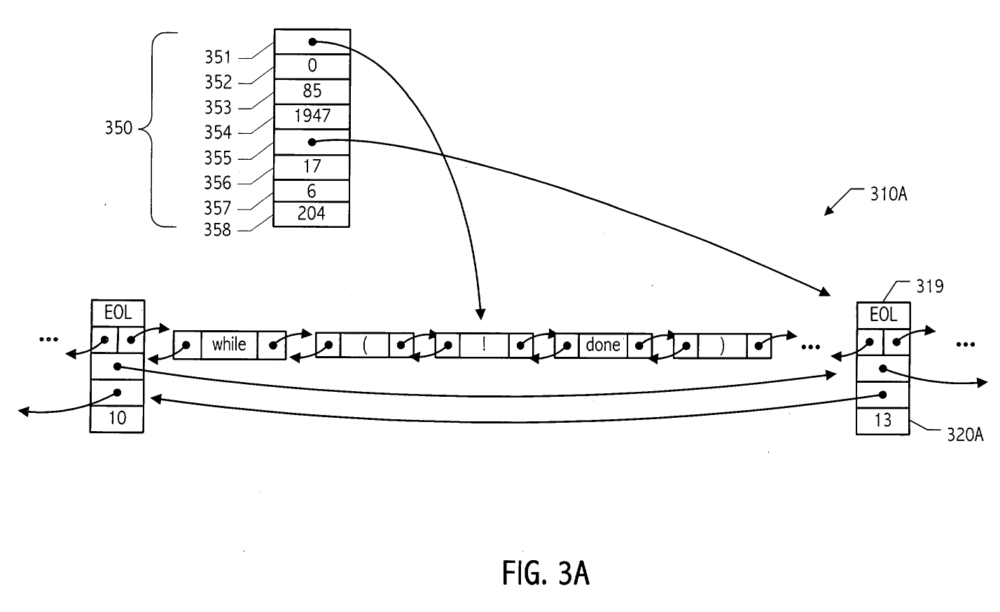

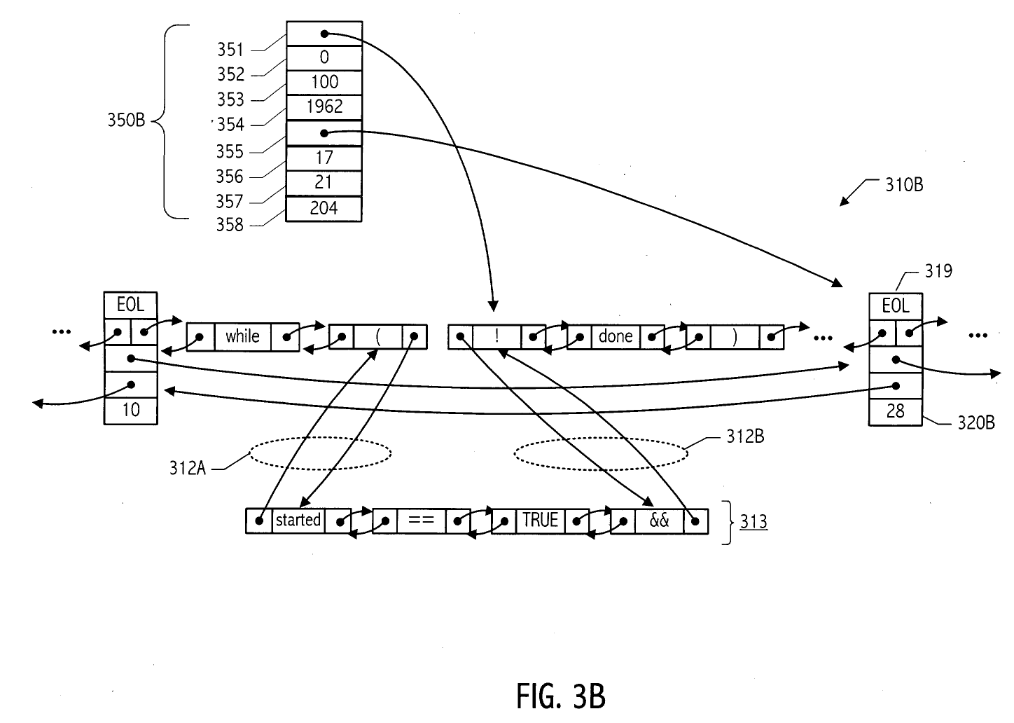

FIGS. 3A and 3B illustrate successive states of a tokenized program representation that is manipulated in response to an insert operation (i.e., an operation that inserts one or more tokens). In FIG. 3A, we illustrate a partial state 310A of the tokenized program representation in which program code has been tokenized in accordance with lexical rules appropriate for a programming language, such as the C programming language. For simplicity of illustration, only a partial state corresponding to a fragment,

. . . while (!done) . . . ,

of the total program code is illustrated and the illustrated insertion adds a token chain corresponding to an additional predicate.

Insertion point representation 350 depicts an insertion point state corresponding to a position immediately preceding the “!” character as it exists prior to operation of the illustrated insertion. In particular, insertion point representation 350 includes a token-coordinates representation, i.e., pointer 351 identifies the corresponding node of the tokenized program representation and offset 352 identifies the offset (in this case, offset=0) thereinto. Line-coordinates are further represented in insertion point representation 350 using pointer 355 (which identifies EOL token 319) and an offset thereinto (see field 357, encoding an offset of 6 character positions into the line identified by pointer 355). As before, polarity (e.g., direction) and base for line offset calculations is, by convention from positive from beginning of line although other conventions may be employed in other realizations. Insertion point representation 350 caches a line number (e.g., line 17, see field 356) corresponding to the insertion point. EOL token 319 optionally encodes a line length (e.g., 13 character positions, see field 320A and insertion point representation 350 optionally caches a total line count (e.g., 204 total lines, see field 358). Additional optional fields 353 and 354 encode a character-coordinates representation and total buffer length respectively.

Turning to FIG. 3B, we illustrate the result of an insertion into the tokenized program representation (pre-insertion state 310A) of four additional tokens (fragment 313) corresponding to user edits of the program code. In the illustration of FIG. 3B, updates to bi-directional pointers 312A and 312B effectuate the token insertion into the tokenized program representation resulting in post-insertion state 310B. A post insertion state 350B of the insertion point is maintained in correspondence with the insertion. Based on the illustrated insertion point convention and the particular insertion illustrated, no update to token identifier or offset thereinto is necessary. However, additional fields that encode a character-coordinates representation, total buffer length and line offset are updated in accordance with the particulars of inserted fragment 313. In particular, line offset (field 357) is updated to reflect the insertion of 15 character positions. Field 320B of EOL token 319 is similarly updated. In the illustrated configuration, any between-token whitespace is excluded in the calculation of updated character coordinates and total buffer length although other conventions may be employed in other implementations. Simple arithmetic updates based in the length of strings corresponding to inserted fragment 313 are suitable.

Of note, a sequence of N tokens (including corresponding strings) can be inserted into, or deleted from, an arbitrary sequence of characters of arbitrary length stored as illustrated above, all in O(N) time. The O(N) computational overhead associated with insertion or deletion includes updates to the next EOL pointer and to line number and line offset cached in the insertion point representation. If EOL tokens are inserted or deleted (e.g., in the case of a multiline insertion or deletion) links amongst the EOL are also updatable in O(N) time. In short, when a linear sequence of characters is stored as a doubly-linked list of tokens (with corresponding strings), insertion of new characters is implemented as an insertion of one or more list nodes. Similarly, deletion is implemented as excision of one or more list nodes. In either case, computational costs are advantageously independent of total buffer length.

Based on the description above, persons of ordinary skill in the art will appreciate a variety of suitable functional implementations to support the above-described insertions and deletions. The exemplary code that follows illustrates one such suitable functional implementation and will be understood in the context of the following data structure or class definitions.

```
// Represents a token in a doubly linked list.
// There are sentinel tokens at each end of the list, so that
// no pointers in tokens which are proper members of the list
// are null.
class Token {
  public Token next;
  public Token previous;
  public String text;
  ....
}
// Represents a special End of Line token in a doubly linked list of
// text tokens. All the End of Line tokens in a stream are themselves
// doubly linked, including the Beginning of Stream and End of Stream
// sentinels (which are special cases of End of Line tokens). The
End
// of Line token contains a cache of the number of characters between
// this token and the previous End of Line token (excluding the
// newline characters they contain).
class EOLToken extends Token {
  public EOLToken nextEOL = null;
  public EOLToken previousEOL = null;
  public int lineLength = 0;
  ...
}
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  EOLToken bos = new EOLToken( );
  EOLToken eos = new EOLToken( );
  int lineCount = 0;
  ...
}
// Represents a character position where editing operations may be
// performed in a doubly linked list of token nodes. The position is
// represented, and maintained, in two formats:
// - a pointer to a token and a character offset into the token
// - a line number and a character offset into the line
// The point also maintains a pointer to the EOLToken that terminates
// the current line; this may be the same token, when point is
// positioned at EOL, and it may be the EOS sentinel when point is
// positioned at EOF.
class Point {
  public TokenStream stream;
  public Token token;
  public int tokenOffset;
  public int lineNumber;
  public int lineOffset;
  public EOLToken eol;
  ...
}
```

Note that, for clarity, character-coordinate handling is omitted from the exemplary code although persons of ordinary skill in the art will appreciate suitable additions, if desired. In particular, character-coordinates facilities detailed in co-pending U.S. patent application Ser. No. 10/185,753, which is incorporated herein by reference may be incorporated, if desired.

Turning now to support for token-coordinates and line-coordinates, the following exemplary code illustrates one suitable functional implementation of an insert operation.

```
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  ...
  // Method for inserting tokens into a doubly linked list at a
  // point between tokens.
  // Precondition:
  // - <point> refers to the beginning of a token in a doubly
linked
  //   list of Tokens with sentinels, or possibly to the ending
  //   sentinel. <point>.tokenOffset thus must be 0.
  // - <first> refers to the first of a doubly linked list of at
  //   least one Token, which are not in the list referred to by
  //   <point>;
  // - <last> refers to the last of these tokens
  // Postcondition:
  // - <point> points to the same position.
  // - The tokens beginning with <first> and ending with <last> are
  //   in the token list, which is otherwise unchanged, immediately
  //   prior to the token pointed to by <point>.
  // - The cached values in <point> for line number and line
offset,
  //   as well as the stream's line count and line sizes are
  //   updated.
  public void insert(TokenList tokenList, Point point) {
    Token lastBefore = point.token.previous;
    Token firstAfter = point.token;
    lastBefore.next = tokenList.first;
    tokenList.first.previous = lastBefore;
    tokenList.last.next = firstAfter;
    firstAfter.previous = tokenList.last;
    int oldLeadingChars = point.lineOffset;
    int oldFollowingChars = point.eol.lineLength -
point.lineOffset;
    int newChars = 0;
    int newLines = 0;
    for (Token t = tokenList.first; t != firstAfter; t = t.next) {
      if (t.isEOL( )) {
        EOLToken tEOL = (EOLToken)t;
        point.eol.previousEOL.nextEOL = tEOL;
        tEOL.previousEOL = point.eol.previousEOL;
        tEOL.nextEOL = point.eol;
        point.eol.previousEOL = tEOL;
        tEOL.lineLength = oldLeadingChars + newChars;
        newLines++;
        oldLeadingChars = 0;
        newChars = 0;
      } else {
        newChars += t.text.length( );
      }
    }
    lineCount += newLines;
    point.lineOffset = oldLeadingChars + newChars;
    point.lineNumber += newLines;
    point.eol.lineLength = oldLeadingChars + newChars +
                      oldFollowingChars;
  }
  ...
}
```

The preceding code is object-oriented and is generally suitable for use in a implementation framework such as that presented by the Java Foundation Classes (JFC) integrated into Java 2 platform, Standard Edition (J2SE). However, other implementations, including procedural implementations and implementations adapted to particular design constraints of other environments, are also suitable.

Arithmetic manipulations to support offset updates including token and line offsets (as well as character offsets, if provided) together with updates to total line counts and line length (as well as total buffer length, if provided) are simple and suitable code modifications corresponding to any particular base/offset convention employed will be appreciated based on the description herein. In general, in implementations that maintain insertion point information (as described above), line-coordinates of a current insertion point (as well as character-coordinates, if provided) can be determined in O(1), i.e., constant time, through simple arithmetic adjustments consistent with the character length of fragments inserted or removed from the tokenized program representation.

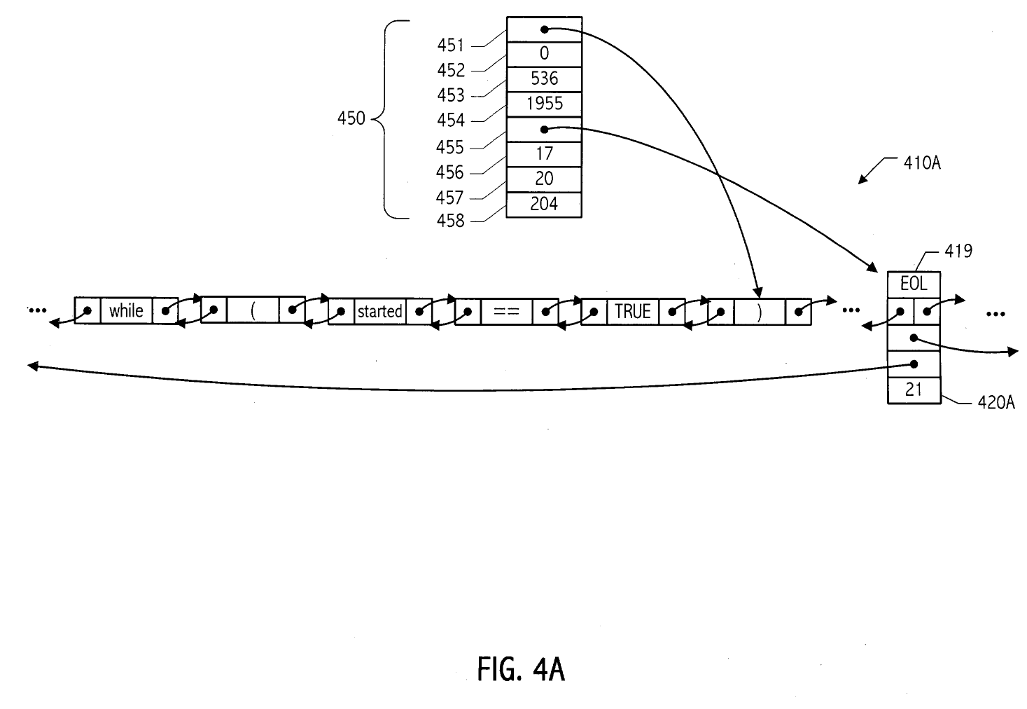

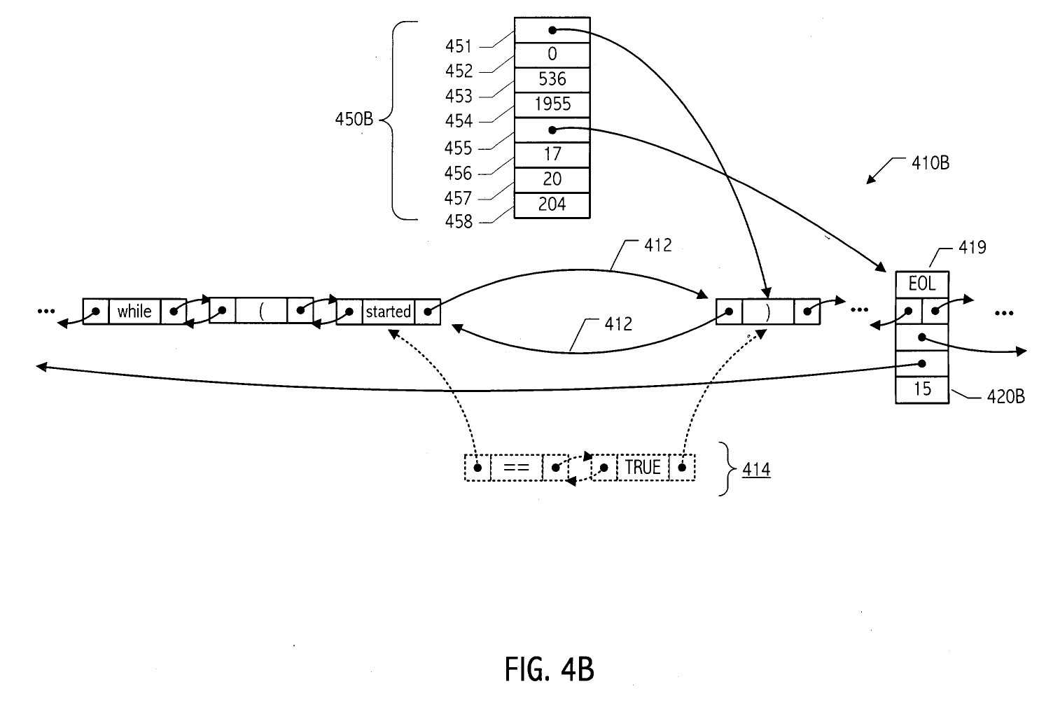

FIGS. 4A and 4B illustrate successive states of a tokenized program representation that is manipulated in response to a remove operation (i.e., an operation that removes one or more tokens). As before, FIG. 4A illustrates an initial partial state 410A of a tokenized program representation. For simplicity, only a partial state corresponding to a fragment,

. . . while (started==TRUE) . . . ,

of the total program code is illustrated and the illustrated deletion removes tokens corresponding to potentially superfluous code.

Insertion point representation 450 depicts an insertion point state corresponding to a position immediately preceding the “)” character as it exists prior to the operation of the illustrated removal. In particular, insertion point representation 450 includes a token-coordinates representation, i.e., pointer 451 identifies the corresponding node of the tokenized program representation and offset 352 identifies the offset (in this case, offset=0) thereinto. Line coordinates are represented in insertion point representation 450 using pointer 455 (which identifies EOL token 419) and an offset thereinto (see field 457, encoding an offset of 20 character positions into the line identified by pointer 455). Insertion point representation 450 caches a line number (e.g., line 17, see field 456) corresponding to the insertion point. EOL token 419 optionally encodes a line length (e.g., 21 character positions, see field 420A) and insertion point representation 450 optionally caches a total line count (e.g., 204 total lines, see field 458). Additional optional fields 453 and 454 encode a character-coordinates representation and total buffer length respectively.

FIG. 4B then illustrates the result of a removal from the tokenized program representation (i.e., from pre-removal state 410A) of two tokens (fragment 414) corresponding to user edits of the program code. In the illustration of FIG. 4B, bi-directional pointers 412 are updated to bridge the excised fragment 414. A post removal state 450B of the insertion point is maintained in correspondence with the removal. Based on the illustrated insertion point convention and the particular removal illustrated, no update to token identifier or offset thereinto is necessary. However, additional fields that encode line offset (as well as a character-coordinates representation and total buffer length, if provided) are updated in accordance with the particulars of excised fragment 414. In particular, line offset (see field 457) is updated to reflect the deletion of 6 character positions. Field 420B of EOL token 419 is similarly updated. As before, between-token whitespace is excluded in the calculation of updated offsets, character coordinates and total buffer length although other conventions may be employed in other implementations. Simple arithmetic updates based in the length of strings corresponding to excised fragment 314 are suitable. The exemplary code that follows illustrates one suitable functional implementation of the above-described token removal.

```
// Represents a stream of tokens, represented as a doubly linked list
// with beginning and ending sentinels. Special End of Line tokens
// separate lines, and are doubly linked together, including the
// special Beginning of Stream and End of Stream sentinels (which are
// special instances of End of Line tokens).
// The total number of lines in the stream is cached at all times.
public class TokenStream {
  ...
  // Method for deleting tokens from a doubly linked list
  // Precondition:
  // - <first> and <last> point to tokens in a doubly linked list
  //   of Tokens with sentinels
  // - The token <first> is either the same as, or prior to the
token
  //   <last> in the list
  // - <point> refers to the beginning of the token just after
<last>
  // Postcondition:
  // - The tokens beginning with <first> and ending with <last> are
  //   no longer in the token list, which is otherwise unchanged.
  // - The cached values in <point> for line number and line
offset,
  //   as well as the stream's line count and line sizes are
updated.
  public void delete(Token first, Token last, Point point) {
    Token lastBefore = first.previous;
    Token firstAfter = last.next;
    EOLToken firstEOL = null;
    int deletedCharacters = 0;
    int deletedFirstLineCharacters = 0;
    int deletedLines = 0;
    for (Token t = first; t != firstAfter; t = t.next) {
      if (t.isEOL( )) {
        deletedLines++;
        if (firstEOL == null) {
          firstEOL = (EOLToken)t;
          deletedFirstLineCharacters = deletedCharacters;
        }
      } else {
        deletedCharacters += t.text.length( );
      }
    }
    lastBefore.next = firstAfter;
    firstAfter.previous = lastBefore;
    if (firstEOL == null) {
      point.lineOffset −= deletedCharacters;
      point.eol.lineLength −= deletedCharacters;
    } else {
      EOLToken lastEOLBefore = firstEOL.previousEOL;
      lastEOLBefore.nextEOL = point.eol;
      point.eol.previousEOL = lastEOLBefore;
      int leadingCharacters = firstEOL.lineLength −
                          deletedFirstLineCharacters;
      int followingCharacters = point.eol.lineLength −
                            point.lineOffset;
      point.lineOffset = leadingCharacters;
      point.eol.lineLength = leadingCharacters +
                        followingCharacters;
      point.lineNumber −= deletedLines;
      lineCount −= deletedLines;
    }
  }
  ...
}
```

While the previously described insertion and removal operations have been illustrated primarily in the context of a single operation, based on the description herein, persons of ordinary skill in the art will recognize that in a typical editing session, or for that matter, in the course of operation another programming tool, multiple insertions and removals of program fragments will occur. Indeed, large number of such insertions and removals will occur and, in general, can be represented as an ordered set of such operations. Often, one operation (e.g., a removal) will operate on results of the previous operation (e.g., an insertion).

Some embodiments in accordance with the present invention offer particularly efficient computation of, or access to, particulars for a tokenized program representation (e.g., 110) and an insertion point representation (e.g., 150). While not all features of the exemplary configurations(s) described above are necessarily included in every realization in accordance with the present invention, several observations are notable at least for an exemplary configuration that includes a superset of disclosed features. First, a line number for the current line containing the insertion point (see e.g., field 156), an insertion point offset into the current line (see e.g., field 157), a current line length (see e.g., field 120 of EOL token 119) and a total line count (see e.g., field 158) can all be retrieved in constant, i.e., O(1), time since each is maintained consistent with access (e.g., insertion and deletion) and repositioning operations. For some software engineering and/or editing tools efficient retrieval can be advantageous. In some variations that also provide character-coordinates, a character offset (see e.g., field 153) from beginning of buffer or stream and a total character count (see e.g., field 154) are also provided and retrievable in constant, i.e., O(1), time since each is maintained consistent with access (e.g., insertion and deletion) and repositioning operations. Additionally, the first and last tokens of the current line can be determined in constant, i.e., O(1), time since an eol pointer (see e.g., field 155) that identifies a current line EOL token (see e.g., EOL token 119) is maintained and the current line EOL token itself includes a previousEOL pointer that identifies the preceding EOL token (e.g., EOL token 119A).

Repositioning the insertion point generally involves traversing the tokenized program representation forward or backward from a current insertion point. Some embodiments in accordance with the present invention offer particularly efficient computation of particulars for a repositioned insertion point. While not all features of the exemplary configuration(s) described above are necessarily included in every realization in accordance with the present invention, several observations are notable, at least for an exemplary configuration that includes a superset of disclosed features.

First, relative repositioning of the insertion point to a new position can involve scanning forward or backward from a current insertion point, a node at a time, updating cached insertion point information such as line offset (e.g., field 157) and, if a line boundary is crossed, current line eol pointer (e.g., field 155) and current line number (e.g., field 156). Each of these operations takes constant, i.e., O(1), time so incremental character position by character position repositioning of the insertion point still scales, at worst as O(N) in the size, N, of the move, not the size of the program or buffer content. Relative movement can be further optimized, however. In particular, repositioning the insertion point to some relative position, whether specified in terms of line and line offset (or in terms of character offset, if supported) can be performed with computation that scales as O(L)+O(T), where L is the number of lines (i.e., EOL tokens) traversed and T is the number of tokens in the target line. Accordingly, by exploiting the pointer chain that links successive EOL tokens, such a repositioning operation can be performed quite efficiently. Whether the desired location is in a particular line can be determined by examining the line length cached in the EOL token (e.g., in field 120 of EOL token 119).

Second, arbitrary repositioning can be similarly performed and optimized. For example, repositioning the insertion point to some arbitrary position, whether specified in terms of line and line offset (or in terms of character offset, if supported) can be performed with computation that scales as O(L)+O(T), where (as before) L is the number of lines (i.e., EOL tokens) traversed (e.g., from the beginning of buffer) and T is the number of tokens in the target line. Arbitrary repositioning can be further optimized by considering the option to start traversing from the beginning of buffer, end of the buffer, or current insertion point (e.g., a relative repositioning). In short, by comparing the target location with the beginning of the program (i.e., line 0), to the end of the buffer whose position corresponds to the last line and (optionally) to the current insertion point, an efficient traversal path (e.g., from beginning, end or “middle”) can be selected. In some cases it may take significantly less time to traverse the path so selected. Of course, starting positions other than, or in addition to, those described could be employed.

Finally, even relative repositioning can be further optimized, if desired, by selected an efficient traversal path. As before, by comparing a relatively-addressed target location with the beginning of the program (i.e., line 0), to the end of the buffer whose position corresponds to the last line, an alternate traversal path (e.g., from beginning or end) can be selected. In some cases it may take significantly less time to traverse the path so selected.

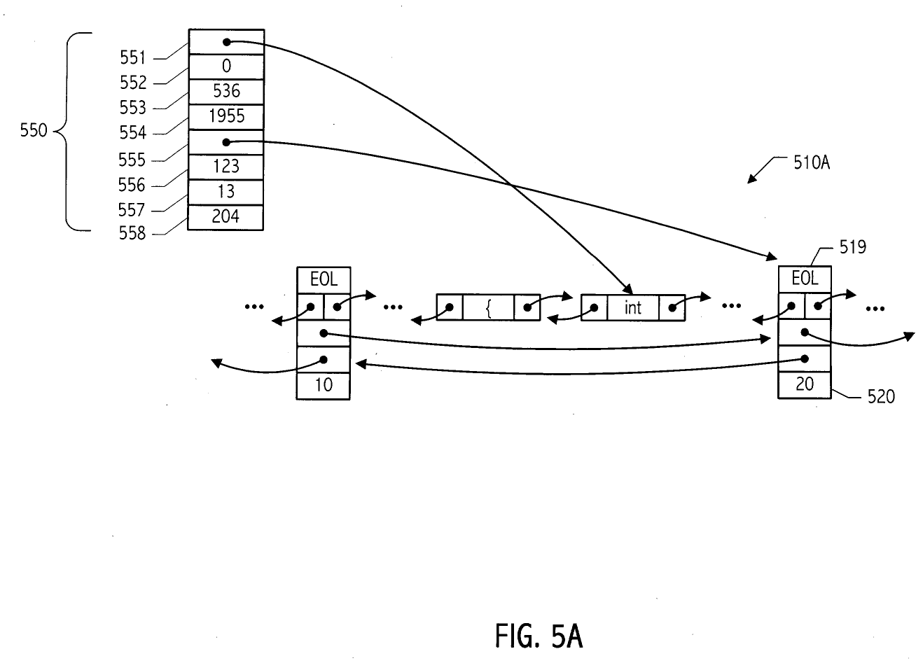

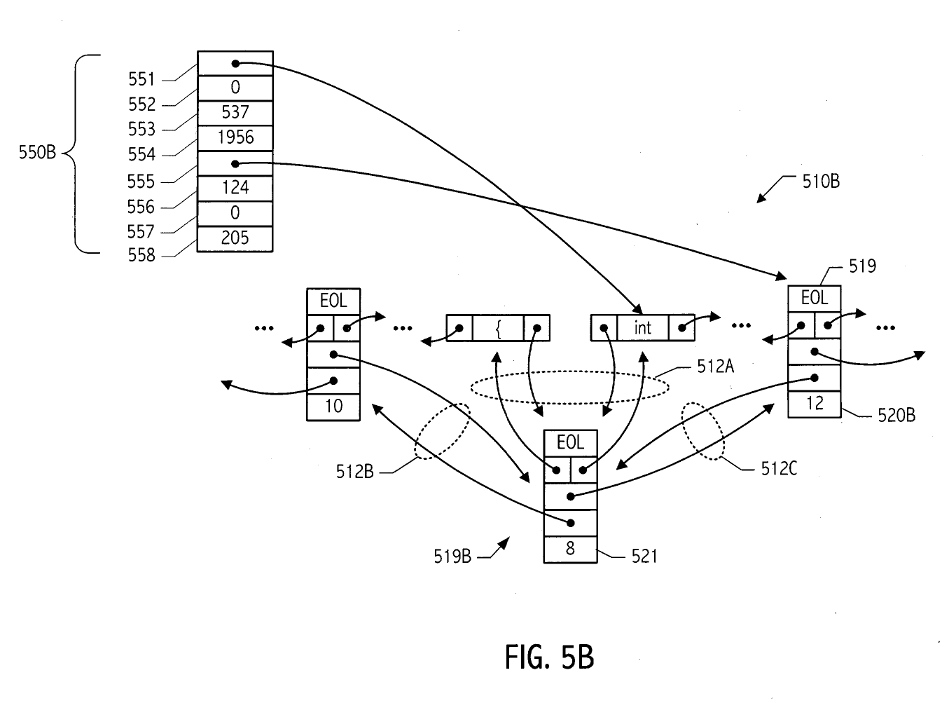

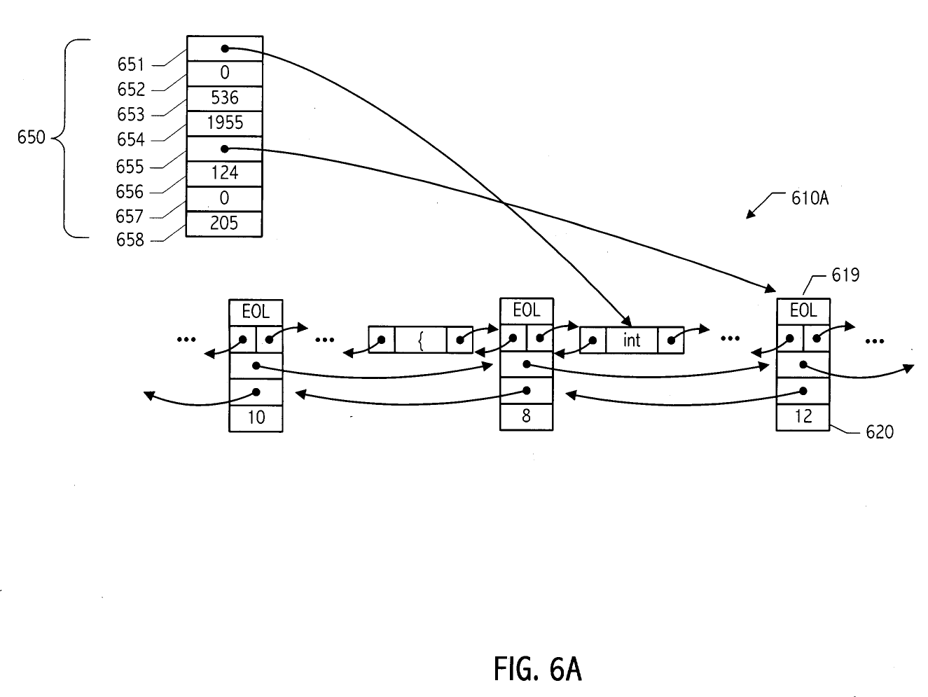

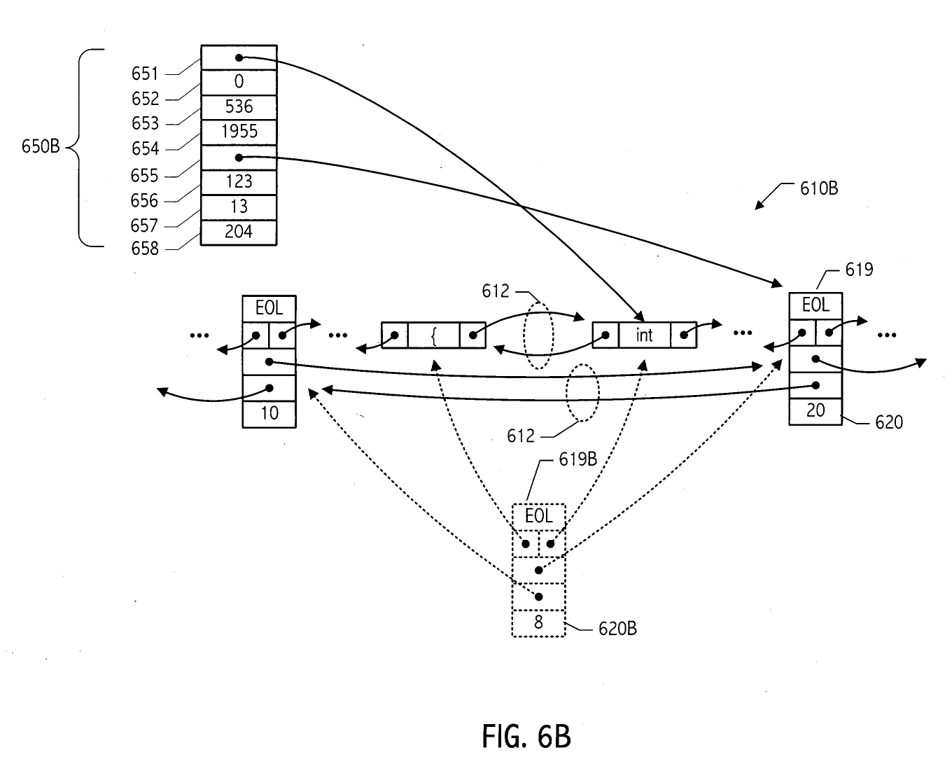

While the illustrations of FIGS. 3A, 3B, 4A and 4B focused on insertions that did not introduce additional lines (and associated EOL tokens) and deletions that did not remove lines (and associated EOL tokens), persons of ordinary skill in the art will recognize that the exemplary functional code (above) fully contemplates such situations. Accordingly, FIGS. 5A and 5B illustrate an insertion which introduces an additional line boundary and associated EOL. FIGS. 6A and 6B illustrate a deletion that removes a line boundary and associated EOL.

FIG. 5A illustrates an initial partial state 510A of a tokenized program representation. For simplicity, only a partial state corresponding to a fragment,

. . . { int . . . ,

of the total program code is illustrated and the illustrated insertion adds a token corresponding to an additional newline. Based on the example and other description herein, persons of ordinary skill in the art will appreciate handling of any insertion that includes a newline.

Insertion point representation 550 depicts an insertion point state corresponding to a position immediately preceding the “i” character in “int” as it exists prior to the operation of the illustrated insertion. As before, insertion point representation 550 includes a token-coordinates representation, i.e., pointer 551 identifies the corresponding node of the tokenized program representation and offset 552 identifies the offset (in this case, offset=0) thereinto. Line-coordinates are further represented in insertion point representation 550 using pointer 555 (which identifies EOL token 519) and an offset thereinto (see field 557, encoding an offset of 13 character positions into the line identified by pointer 555). Insertion point representation 550 caches a line number (e.g., line 123, see field 556) corresponding to the insertion point. EOL token 519 optionally encodes a line length (e.g., 20 character positions, see field 520) and insertion point representation 550 optionally caches a total line count (e.g., 204 total lines, see field 558). Additional optional fields 553 and 554 encode a character-coordinates representation and total buffer length respectively.

Turning to FIG. 5B, we illustrate the result of an insertion into the tokenized program representation (pre-insertion state 510A) of an additional token (EOL token 519B) corresponding to user edits of the program code. In the illustration of FIG. 5B, updates to bi-directional pointers 512A, 512B and 512C effectuate the token insertion into the tokenized program representation resulting in post-insertion state 510B. A post insertion state 550B of the insertion point is maintained in correspondence with the insertion. Based on the illustrated insertion point convention and the particular insertion illustrated, no update to token identifier or offset thereinto is necessary. Additional fields that encode a character-coordinates representation and total buffer length (if provided) are updated assuming that, at least in this case, by convention, whitespace is accorded a “width” of 1 character position.

However, current line number, line offset, total line count and certain EOL token fields are updated in accordance with the insertion of EOL token 519B. In particular, line count (field 556) is updated to reflect that the current line containing the insertion point is now line 124 in the buffer and line offset (field 557) is updated to indicate that the insertion point now resides at character position 0 of the current line. Field 520B of EOL token 519 and field 521 of EOL token 519B are similarly updated to reflect allocation of character positions to the respective lines.

FIG. 6A illustrates an initial partial state 610A of a tokenized program representation. For simplicity, a state corresponding to that illustrated in FIG. 5B is illustrated.

Insertion point representation 650 depicts an insertion point state corresponding to a position immediately preceding the “i” character in “int” as it exists prior to the operation of the illustrated removal. In particular, insertion point representation 650 includes a token-coordinates representation, i.e., pointer 651 identifies the corresponding node of the tokenized program representation and offset 652 identifies the offset (in this case, offset=0) thereinto. Line coordinates are represented in insertion point representation 650 using pointer 655 (which identifies EOL token 619) and an offset thereinto (see field 657, encoding an offset of 0 character positions into the line identified by pointer 655). EOL token 619 encodes a line length (e.g., 12 character positions, see field 620). As before, insertion point representation 650 optionally caches a line number (e.g., line 124, see field 656) corresponding to the insertion point and a total line count (e.g., 205 total lines, see field 658). Additional optional fields 653 and 654 encode a character-coordinates representation and total buffer length respectively.

FIG. 6B then illustrates the result of a removal from the tokenized program representation (i.e., from pre-removal state 610A) of a newline (EOL token 619B) corresponding to user edits of the program code. In the illustration of FIG. 6B, bi-directional pointers 612 are updated to bridge excised EOL token 619B. A post removal state 650B of the insertion point is maintained in correspondence with the removal. Based on the illustrated insertion point convention and the particular removal illustrated, no update to token identifier or offset thereinto is necessary. However, current line number, line offset, total line count and an EOL token field are updated in accordance with the removal of EOL token 619B. In particular, line count (field 656) is updated to reflect that the current line containing the insertion point is now line 123 in the buffer and line offset (field 657) is updated to indicate that the insertion point now resides at character position 13 of the current line (now rejoined). Field 620 of EOL token 619 is similarly updated to reflect allocation of character positions to the current line.

Exemplary Editor Implementation

In general, techniques of the present invention may be implemented using a variety of editor implementations. Nonetheless, for purposes of illustration, the description of exemplary editor implementations in U.S. Pat. No. 5,737,608, entitled “PER-KEYSTROKE INCREMENTAL LEXING USING A CONVENTIONAL BATCH LEXER” is incorporated herein by reference. In particular, while the preceding code implements token operations, persons of ordinary skill in the art will recognize that editor and/or programming tools implementations may often include operations that operate at a level of abstraction that corresponds to character manipulations. Such character-oriented manipulations typically affect the state of an underlying token-oriented representation and such state changes can be effectuated using token operations such as the insertion and removal operations described herein. Of course, alternate and/or additional operations may be appropriate in other implementations. To generate sequences of token-oriented operations that correspond to character manipulations, incremental lexing techniques described in the '608 patent may be employed in some realizations.

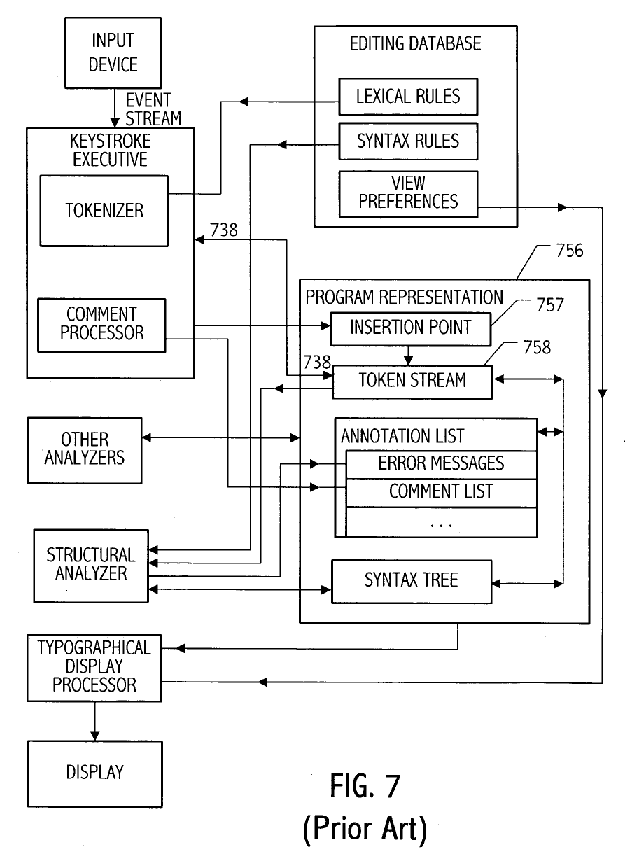

FIG. 7 depicts interactions between various functional components of an exemplary editor implementation patterned on that described in greater detail in the '608 patent. In particular, techniques of the present invention are employed to implement program representation 756, and particularly token stream representation 758 and insertion point representation 757, to support efficient edit and repositioning operations. By implementing operations 738, including insert and remove operations, on token stream representation 758 as described above, such efficiency is provided. Based on the description herein, including the above-incorporated description, persons of ordinary skill in the art will appreciate a variety of editor implementations that may benefit from features and techniques of the present invention.

While the invention has been described with reference to various embodiments, it will be understood that these embodiments are illustrative and that the scope of the invention is not limited to them. Many variations, modifications, additions, and improvements are possible. In particular, a wide variety of lexical contexts may be supported. For example, while a lexical context typical of program code has been illustrated, other lexical contexts such as those appropriate to markup languages, comments, even multimedia content may be supported. Similarly, although much of the description has focused on functionality of an editor, the techniques described herein may apply equally to other interactive or even batch oriented tools. While lexical analysis of textual content has been presumed in many illustrations, persons of ordinary skill in the art will recognize that the techniques described herein also apply to structure-oriented editors and to implementations that provide syntactic, as well as lexical, analysis of content.

More generally, plural instances may be provided for components described herein as a single instance. Boundaries between various components, operations and data stores are somewhat arbitrary, and particular operations are illustrated in the context of specific illustrative configurations. Other allocations of functionality are envisioned. Structures and functionality presented as discrete in the exemplary configurations may be implemented as a combined structure or component. These and other variations, modifications, additions, and improvements may fall within the scope of the invention as defined in the claims that follow.

What is claimed is:

1. A software engineering tool encoded in one or more computer readable media as instructions executable to represent program code as a doubly-linked list of lexical tokens including at least some line demarcations corresponding to line boundaries in the represented program code, the instructions further executable to maintain, consistent with operations thereon, both a token-coordinates representation and a line-coordinates representation of an insertion point.

2. The software engineering tool of claim 1,
wherein the line-coordinates representation encodes both a line and a line offset therein corresponding to the insertion point.

3. The software engineering tool of claim 1,
wherein the line demarcations are embodied as end-of-line (EOL) tokens.

4. The software engineering tool of claim 1,
wherein forward and backward pointers at least partially define the doubly-linked list; and
wherein additional line-related pointers are associated with the line demarcations, the line-related pointers identifying respective previous and next line demarcations of the doubly-linked list.

5. The software engineering tool of claim 1,
wherein for a given line of the program code, a character count therefor is encoded in, or in association with, a corresponding one of the line demarcations.

6. The software engineering tool of claim 1,
wherein the operations include insertion point repositioning operations.

7. The software engineering tool of claim 1,
wherein the operations include edit operations.

8. The software engineering tool of claim 7, wherein the edit operations include one or more of:
insertion operations; and
removal operations.

9. The software engineering tool of claim 1,
wherein the token-coordinates representation identifies both a particular one of the lexical tokens and a substring offset into a substring associated with the particular lexical token.

10. The software engineering tool of claim 1,
wherein, coincident with movement of the insertion point to a new position in the program code, the maintaining includes traversing from a particular position in the doubly-linked list toward the new position, and updating both the token-coordinates representation and line-coordinates representation of the insertion point in correspondence therewith.

11. The software engineering tool of claim 10,
wherein the particular position corresponds to the insertion point.

12. The software engineering tool of claim 10,
wherein the particular position corresponds to one of:
a first line of represented program code,
the insertion point, and
a last line of the represented program code,
selected based on comparison with the new position to generally minimize computational overhead associated with the scanning and updating.

13. The software engineering tool of claim 10,
wherein computational overhead associated with the scanning and updating is generally insensitive to length of the represented program code, and instead exhibits no greater than O(L)+O(T) scaling behavior, where L corresponds to scale of line displacement from the particular position to the new position and T corresponds to scale of character displacement in a line that includes the new position.

14. The software engineering tool of claim 1,
wherein the instructions are further executable to maintain, consistent with each operation that modifies the program code, a total line count.

15. The software engineering tool of claim 1, configured as one or more of:
an editor;
a source level debugger;
a class viewer;
a profiler;
a style checker,
a compiler or interpreter; and
an integrated development environment.

16. The software engineering tool of claim 1,
wherein the one or more computer readable media are selected from the set of a disk, tape or other magnetic, optical, or electronic storage medium and a network, wireline, wireless or other communications medium.

17. A method of identifying an insertion point in an edit buffer represented as a sequence of lexical tokens, the method comprising:
representing the edit buffer as a doubly-linked list of nodes, each node corresponding to a respective one of the lexical tokens; and
representing the insertion point in the edit buffer, the insertion point representation identifying:
(i) a particular one of the lexical tokens corresponding to the insertion point; and
(ii) line coordinates for the insertion point.

18. The method of claim 17, further comprising:
including in the doubly-linked list, nodes corresponding to end-of-line (EOL) tokens that mark respective line boundaries in the edit buffer.

19. The method of claim 17,
wherein the line coordinates encode both a row and a column corresponding to the insertion point.

20. The method of claim 17,
associating with the EOL tokens line-related pointers that identify respective prior and later EOL tokens of the doubly-linked list and that facilitate line-by-line traversal of the edit buffer.

21. The method of claim 17,
wherein for a given line of the edit buffer, a character count therefor is encoded in, or in association with, a corresponding one of the EOL tokens.

22. The method of claim 17, further comprising:
maintaining, coincident with an operation that modifies contents of the edit buffer, the insertion point representation.

23. The method of claim 22,
wherein the operation that modifies contents of the edit buffer includes one or more of an insert, remove, split, join or replace operation performed at the insertion point.

24. The method of claim 17, further comprising:
maintaining, coincident with movement of the insertion point to a new position, the insertion point representation.

25. The method of claim 24,
wherein the maintaining includes scanning from a particular position in the doubly-linked list toward the new position, and updating the identification of both the particular lexical token and the line coordinates.

26. The method of claim 25,
wherein the particular position corresponds to the insertion point.

27. The method of claim 25,
further comprising maintaining a representation of total character count for the edit buffer; and
wherein the particular position corresponds to one of:
a first line of the edit buffer,
the insertion point, and
a last line of the edit buffer,
selected based on comparison with the new position to generally minimize computational overhead associated with the scanning and updating.

28. One or more computer readable media encoding a data structure that represents contents of an edit buffer as a sequence of lexical tokens, the encoded data structure comprising:
a doubly linked list of nodes;
token representations each corresponding to at least one respective node of the list, wherein at least some of the token representations have associated string encodings; and
an insertion point representation identifying, for the insertion point, both a particular one of the lexical tokens and a particular line in which the particular token resides.

29. The encoded data structure of claim 28,
wherein the particular line identification encodes both a row and a column corresponding to the insertion point.

30. The encoded data structure of claim 28,
wherein the insertion point representation further includes an offset in to a text string associated with the particular token.

31. The encoded data structure of claim 28, embodied as a software object that defines at least one operation that repositions the insertion point,
wherein performance of the repositioning operation updates both the particular lexical token and the particular line.

32. The encoded data structure of claim 28, embodied as a software object that defines edit operations on contents of the edit buffer,
wherein, consistent with semantics thereof, each of the edit operations performed on the edit buffer updates the particular lexical token and the particular line.

33. The encoded data structure of claim 28,
wherein the one or more computer readable media are selected from the set of a disk, tape or other magnetic, optical, or electronic storage medium and a network, wireline, wireless or other communications medium.

34. A method of supporting access by one or more software engineering tools to program code, wherein at least one such tool operates on the program code as a token sequence and at least one such tool operates on the program code as a line-delimited character sequence, the method comprising:
maintaining a representation of the program code as a doubly-linked list of nodes, each node corresponding to a lexical token thereof; and
responsive to repositioning of an insertion point, updating a representation thereof that identifies:
a particular one of the lexical tokens;
a character offset into a string associated with the particular lexical token; and
line coordinates corresponding to the identified token and character offset.

35. The method of claim 34, further comprising:
including in the program code representation at least some end-of-line (EOL) tokens corresponding to line boundaries therein.

36. The method of claim 35,
wherein forward and backward pointers at least partially define the doubly-linked list; and
wherein additional line-related pointers are associated with the EOL tokens, the line-related pointers identifying respective previous and next EOL tokens of the doubly-linked list.

37. The method of claim 36, further comprising:
for a given line of program code, encoding a character count in, or in association with, a corresponding one of the EOL tokens.

38. The method of claim 34,
wherein the updating includes updating both a row component and a column component of the line coordinates.

39. The method of claim 34,
wherein the repositioning includes traversing from a particular position in the doubly-linked list toward a new position and updating the insertion point representation in correspondence therewith.

40. The method of claim 34,
wherein the tool that operates on the program code as a token sequence and the tool that operates on the program code as a line-delimited character sequence are different tools.

41. The method of claim 34,
wherein the tool that operates on the program code as a token sequence and the tool that operates on the program code as a line-delimited character sequence are a same tool.

42. The method of claim 34, wherein the tool that operates on the program code as a line-delimited character sequence is configured as one or more of a:
source-level debugger;
a style analyzer; and
a compiler or interpreter.

43. An apparatus comprising:
storage for a computer readable encoding of an edit buffer represented as a sequence of lexical tokens; and
means for representing an insertion point in the edit buffer, the insertion point identifying both a particular one of the lexical tokens and line coordinates.

44. The apparatus of claim 43, further comprising:
means for repositioning the insertion point, the repositioning means traversing the edit buffer line-by-line, and without with traversal of each lexical token of each intervening line so traversed.

45. The apparatus of claim 43,
wherein the insertion point representation means further identifies row and column components of the line coordinates.

46. The apparatus of claim 43,
wherein the insertion point representation means further identifies a substring offset into a substring associated with the particular lexical token.

47. The apparatus of claim 43, further comprising:
means for updating the insertion point in correspondence with a repositioning operation.

48. The apparatus of claim 43, further comprising:
means for maintaining the insertion point in correspondence with an edit operation on the edit buffer.
